(19) United States
(12) Patent Application Publication
(10) Pub. No.: US 2006/0228961 A1
(43) Pub. Date: Oct. 12, 2006

(54) Woven Belt for a Corrugated Board Machine

(75) Inventor: Armin Birzele, Ulm (DE)

Correspondence Address: GUDRUN E. HUCKETT DRAUDT, LONSSTR. 53, WUPPERTAL, 42289, DE

(73) Assignee: MUHLEN SOHN GMBH & CO., Blaustein (DE)

(21) Appl. No.: 11/308,247

(22) Filed: Mar. 14, 2006

Related U.S. Application Data
(63) Continuation of application No. PCT/EP03/10271, filed on Sep. 16, 2003.

(51) Int. Cl. B32B 5/22

(52) U.S. Cl. 442/76

(57) ABSTRACT

A woven belt for a corrugated board machine has a first woven layer made of first warp threads and first weft threads and adapted to take up tensile forces acting on the woven belt. A second woven layer made of second warp threads and second weft threads forms a woven top layer covering the first woven layer. The woven top layer forms a paper side of the woven belt on which paper side corrugated board is supported. The woven top layer is vapor permeable to allow removal of moisture from the paper side. The woven top layer has at least one strip of a friction-increasing material, wherein the at least one strip is narrower in a direction perpendicular to a longitudinal direction of the woven belt than a width of the woven belt.

This application is a continuation application of international patent application PCT/EP2003/010271 having an international filing date of Sep. 16, 2003, not published in English under PCT Article 21(2); the entire disclosure of PCT/EP2003/010271 is herewith incorporated by reference.

### BACKGROUND OF THE INVENTION

The invention relates to a woven belt for a corrugated board machine comprising a first woven layer taking up tensile forces in the longitudinal direction of the woven belt and comprised of first warp threads and first weft threads and comprising a second woven top layer covering the first woven layer and comprised of second warp threads and second weft threads. The second woven top layer forms a paper side for supporting the corrugated board, wherein the woven layers are connected to one another and wherein the woven top layer forming the paper side is vapor permeable in order to remove moisture away from the paper side.

U.S. Pat. No. 5,785,621 discloses a woven belt for a corrugated board gluing machine that ensures over a long period of use at high-quality standard an excellent dewatering of the board material placed on the woven belt. As a result of increasing requirements, it must be ensured that the woven belt has a sufficiently high mechanical strength. This leads to multi-layer woven structures; this however disadvantageously reduces the permeability of the woven belt.

Also, it was found that the paper side of the woven belt under unfavorable conditions or after an extended period of use has only a minimal coefficient of friction so that the transport capability of the woven belt is impaired and the corrugated board resting thereon can slide. This leads to reduced quality and can lead to disruptions in the production process.

### SUMMARY OF THE INVENTION

It is an object of the present invention to develop a woven belt of the aforementioned kind for a corrugated board machine in such a way that over an extended period of use a high coefficient of friction of the paper side is ensured and at the same time the vapor permeability of the belt is not impaired so that a rapid moisture removal from the corrugated board resting on the woven belt is provided.

In accordance with the present invention, this is achieved in that the woven top layer forming the paper side has a strip of friction-increasing material wherein the strip in the direction perpendicular to the longitudinal direction of the woven belt is narrower than the width of the woven belt.

By means of the strip of a friction-increasing material (material that increases the coefficient of friction) on the paper side it is ensured that the belt, even under unfavorable operating conditions and even after long periods of use, still has a high coefficient of friction so that the corrugated cardboard resting thereon can be transported safely and without slippage and the position of the cardboard does not change during the manufacturing process. Since the strips made of friction-increasing material are narrower than the width of the woven belt, independent of the selected coating material the vapor permeability of the woven belt remains intact so that a quick moisture removal from the corrugated cardboard resting on the woven belt is ensured. Even when several of the strips are provided adjacent to one another in the direction perpendicular to the width of the woven belt for obtaining excellent transport properties, an excellent vapor permeability is provided. Preferably, drainage channels for removing moisture are formed in the woven belt between neighboring strips.

In an especially beneficial embodiment of the invention, the strip of friction-increasing material is embodied simply by a warp thread that has an outer friction-increasing coating. Such a warp thread is woven during the weaving process into the paper side and forms with its external side positioned within the paper side a narrow strip of friction-increasing material. Additional processing steps for applying a friction-increasing material strip are not needed.

Preferably, several warp threads with a friction-increasing coating are randomly distributed across the width of the paper side; they are all introduced during the weaving process into the paper side. It can also be advantageous to embody all warp threads of the woven layer forming the paper side to have a friction-increasing coating so that essentially an almost complete coating of the paper side is achieved. Since the coating is comprised of many neighboring warp threads, between neighboring warp threads there are regularly positioned cavities and gaps as a result of the woven structure so that the vapor permeability of the woven belt is maintained despite an essentially complete surface coating.

The coating is advantageously comprised of silicone.

In a further embodiment of the invention, electrically conducting metal fibers are admixed to the thread material of the weft threads and/or of the warp threads so that an electrostatic charging is prevented as much as possible. The thread material with the admixed metal fibers can be provided in the woven layer forming the paper side as well as in the central woven layer and also in an optionally present additional woven layer.

In order to ensure even at high woven density the vapor permeability of the woven belt, it is proposed to use as warp threads and/or weft threads a monofilament wherein the properties of the monofilament ensure the vapor permeability of the woven belt. Monofilaments having, for example, a circular, elliptical or similar cross-section do not substantially change their cross-sectional shape, not even at high pressure, so that even at high packing density between the warp threads and weft threads comprised of individual monofilaments, respectively, there remain cavities. Depending on the woven structure, these cavities are used in order to ensure the vapor permeability of the woven belt based on the woven structure alone.

### BRIEF DESCRIPTION OF THE DRAWING

FIG. 1 shows a woven belt in longitudinal section.

FIG. 2 shows a partial plan view onto the woven top layer forming the paper side.

FIG. 3 is a plan view onto the outer side of the woven bottom layer of the woven belt.

FIG. 4 is a schematic plan view onto the paper side of the woven belt according to FIG. 1.

FIG. 5 is a schematic illustration of another embodiment of a woven belt in longitudinal section.

FIG. 6 is a schematic illustration of a plan view onto the woven top layer forming the paper side of the woven belt according to FIG. 5.

FIG. 7 is a schematic illustration of a plan view onto the woven bottom layer of the woven belt of FIG. 5.

FIG. 8 is a schematic illustration of a further embodiment of a woven belt in longitudinal section.

FIG. 9 is a schematic illustration of a plan view onto the woven top layer forming the paper side of the woven belt of FIG. 8.

FIG. 10 is a schematic illustration of a plan view onto the woven bottom layer of the woven belt of FIG. 8.

### DESCRIPTION OF THE PREFERRED EMBODIMENTS

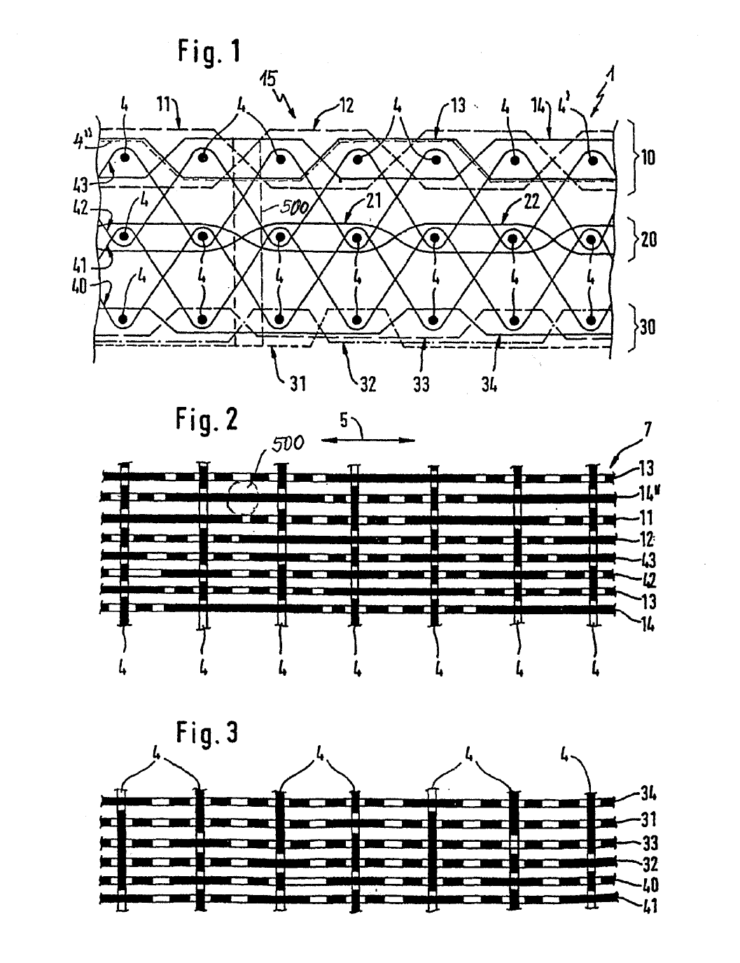

One embodiment of a woven belt 1 is illustrated in FIG. 1. The woven belt 1 preferably made of plastic threads or fibers, particularly monofilaments, is comprised of a woven top layer 10, a woven central layer 20 that takes up tensile forces acting on the woven belt, and a woven bottom layer 30. The side of the woven top layer 10 that is facing away from the woven central layer 20 forms the paper side 15 of the woven belt 1.

In the woven layers 10, 20, 30 the weft threads 4 extend perpendicularly to the longitudinal direction 5 (FIG. 2) of the woven belt 1.

In the woven top layer 10, four warp threads 11, 12, 13, and 14 (FIGS. 1 and 2) are provided that are staggered relative to one another and extend inwardly toward the woven central layer 20 as well as outwardly toward the paper side across advantageously, for example, at least two weft threads 4, respectively.

The woven central layer 20 that takes up the tensile forces has two warp threads 21, 22 that extend staggered relative to one another and cross advantageously, for example, two weft threads 4, respectively.

A woven bottom layer 30 is advantageously also provided as a supplement and is comprised of four warp threads 31, 32, 33, 34 that extend staggered relative to one another in such a way that inwardly towards the woven central layer 20 they extend across at least one weft thread 4 and outwardly advantageously across at least three weft threads 4. Other arrangements can be expedient.

The three woven layers 10, 20, 30 of the illustrated embodiment are connected to one another by binding threads 40, 41, 42, 43. The binding or tying threads 40, 41, 42, 43 are divided respectively into two thread groups wherein the tying threads 42, 43 forming one thread group extend staggered relative to one and bind the woven top layer 10 to the woven central layer 20. The binding threads 42 and 43 advantageously extend alternatingly across a weft thread 4 in the woven top layer 10 and a weft thread 4 in the woven central layer 20. In a corresponding way, the thread group that is comprised of the binding threads 40 and 41 binds the woven bottom layer 30 to the woven central layer 20.

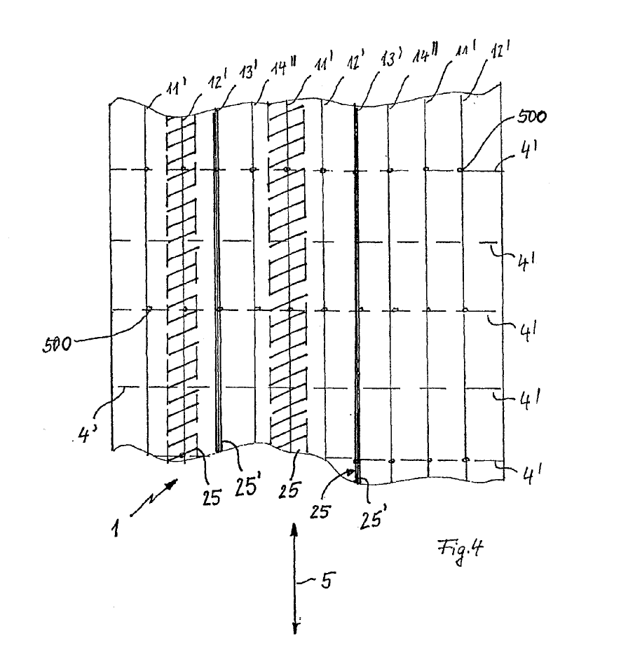

As illustrated in FIG. 4 and as apparent in combination with FIGS. 1 and 3, in the illustrated embodiment the woven top layer 10 forming the paper side 15 of the woven belt 1 has several strips 25 of a friction-increasing coating applied thereto; the strips extend in the longitudinal direction 5 of the woven belt 1 and are positioned at a spacing relative to one another. The strips 25 increase the coefficient of friction between the corrugated board (corrugated cardboard) resting on the woven belt. The corrugated board is supported substantially slip-free and is safely held and secured in position during transport on the woven belt 1. Since the coating strips 25 are narrower than the width of the woven belt, the vapor permeability is maintained despite the presence of the coating.

Alternatively or additionally, warp threads 13′ can be provided with a friction-increasing coatings 25′ and form the friction-increasing coating strips because of their position within the paper side 15. In this connection, in the longitudinal direction of the woven belt individual warp threads 13′ can be provided with a friction-increasing coating and woven into the woven layer or all of the warp threads (11′, 12′, 13′, 14′) and/or also the weft threads 4′ of the paper side 15 can be provided with a friction-increasing coating. The warp threads of the paper side are positioned side by side but do not form as a result of the employed woven structure and/or, for example, the selection of the thread cross-section and also the thread material (monofilaments), a dense impermeable coating; instead, as a result of gaps between neighboring threads a coatings that is permeable for vapor is provided so that moisture can be quickly removed away from the paper side.

As illustrated in FIG. 4, in the woven top layer 10 of the woven belt 1 at least one warp thread 14″ extending in the longitudinal direction 5 of the belt 1 can be arranged which is comprised of cavity-forming thread material, i.e., a thread material that is different from that of the warp threads 11, 12, 13 and 14 of the woven top layer 10 forming the other areas of the woven belt 1 (FIG. 2). The individual warp threads 14″ of the paper-supporting woven layer 10 is comprised of cavity-forming thread material that is in communication with the drainage channels 500. Each drainage channel 500 is preferably a cavity woven mechanically into the fabric (woven material) and extending away from the paper side in the direction toward the bottom side of the belt; in this way, the channels 500 provide a fast and effective drainage (moisture removal) of the coating-free areas of the woven belt. Preferably, the cavity 500 opens at the bottom side of the woven belt that is facing away from the paper side and is formed particularly as a cavity penetrating or passing through the woven belt. As shown in FIG. 4, the cavities 500 are designed like a drain through which the vapor can be removed from the paper side of the woven top layer 10 though the woven belt 1.

The weft threads 4′ and the warp threads 11′, 12′, 13′, and 14″ cross advantageously the drainage channels 500 that are mechanically woven into the woven belt. In particular, the drainage channels 500 are arranged at the crossing points between the weft threads and warp threads.

As a cavity-forming thread material it is possible to use a thread material that has a particularly high starch content; preferably, the thread material consists completely of starch. This has the result that in the dry state the cavity-forming threads consisting of starch or containing a high percentage of starch can be processed like normal threads. In the woven structure, they provide placeholders that will dissolve when coming into contact with liquid, particularly water. The gaps or “defects” that are formed after dissolving the starch and washing out the starch from the fabric form drain passages, drain grooves or the like that open into the mechanically woven-in drainage channels 500. In this way, in the area between the drainage channels 500 a kind of drainage grid is produced that supplies the collected liquid directly to the mechanically woven-in drainage channel 500 and, in this way, ensures a quick dewatering of the cardboard material placed onto the woven belt. In this connection, after a certain period of use the warp threads made of the cavity-forming fiber material form longitudinal channels extending in the longitudinal direction and the weft threads 4′ made of such cavity-forming thread material form transverse channels extending perpendicularly relative to the longitudinal direction. Since the longitudinal channels and the transverse channels as a result of the woven structure (warp threads, weft threads) cross one another, the transverse channels and the longitudinal channels are connected to one another in flow communication. A quick removal of liquid is provided in this way.

As a cavity-forming thread material, hollow fibers can be used also. Over an extended period of use, the hollow fibers will open as a result of wear so that their inner cavities themselves form drain passages that extend in the longitudinal direction of the warp and weft threads.

In order to continue the drainage structure also in the direction of the depth of the woven belt, it is also possible to make the warp and weft threads of the additional woven layers 20 and 30 of cavity-forming thread material. Also, individual binding threads made of cavity-forming thread material can be provided so that in the woven structure drainage passages can be provided from one woven layer 10 to the next woven layer 20.

It can be expedient to provide the cavity-forming thread material as an auxiliary thread of a warp thread, a weft thread or a binding thread in order to avoid a disruption of the woven structure. The number of warp threads, weft threads and binding threads that determine the woven structure remains unchanged; to a warp thread and/or a weft thread and/or a binding thread, an auxiliary thread made of a cavity-forming thread material is added which acts as a placeholder that forms at a later time the desired drainage passage.

FIG. 5 shows a schematic illustration of another embodiment of a woven belt 2 in longitudinal section. The woven belt 2 is comprised of a woven top layer 50 and a woven bottom layer 60. In the woven top layer 50 that forms the paper side four warp threads 51, 52, 53 and 54 staggered relative to one another and in the woven bottom layer 60 four warp threads 61, 62, 63, 64 staggered relative to one another are provided. The weft threads 6 extend transversely to the longitudinal direction 7; the warp threads extend across two weft threads 6. The woven top layer 50 and the woven bottom layer 60 are connected to one another by binding threads 44, 45 wherein the binding threads are staggered relative to one another and extend across one weft thread 6, respectively.

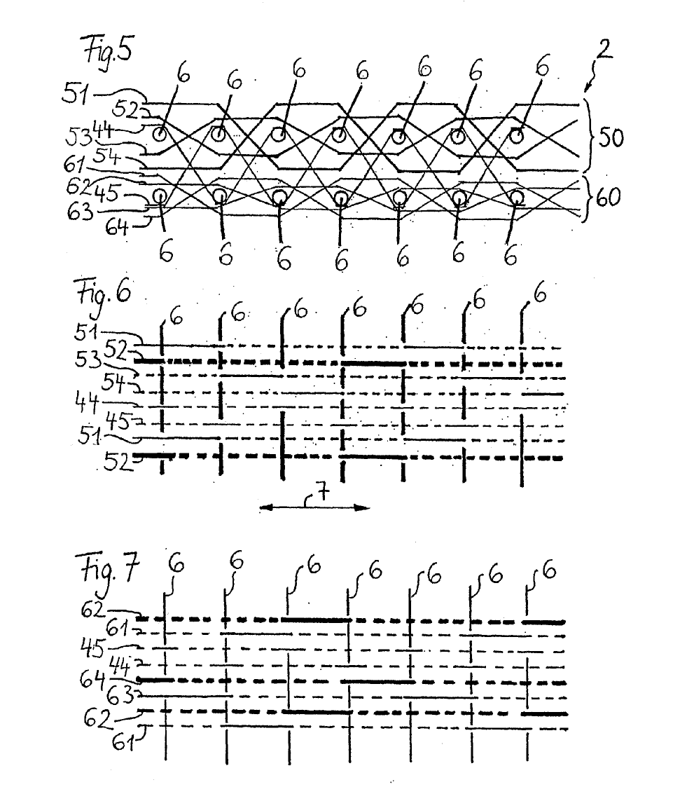

FIG. 6 shows a schematic illustration of a plan view of the woven top layer and FIG. 7 a schematic illustration of the plan view of the woven bottom layer of the same belt section as illustrated in FIG. 6. The four warp threads 51, 52, 53 and 54 are positioned adjacent to one another; adjacently positioned are the two binding threads 44 and 45. The threads of the woven bottom layer 60, as shown in FIG. 7, are woven likewise. The warp thread 52 of the woven top layer 50 and the warp threads 62 and 64 of the woven bottom layer 60 have a greater diameter than the other warp threads. In this way, drainage passages are formed wherein the woven top layer 50 has more drainage passages than the woven bottom layer 60. The drainage passages can also be formed by the thread structure of the warp threads 51 to 54 and 61 to 64. For this purpose, the threads can have, for example, grooves in the longitudinal direction.

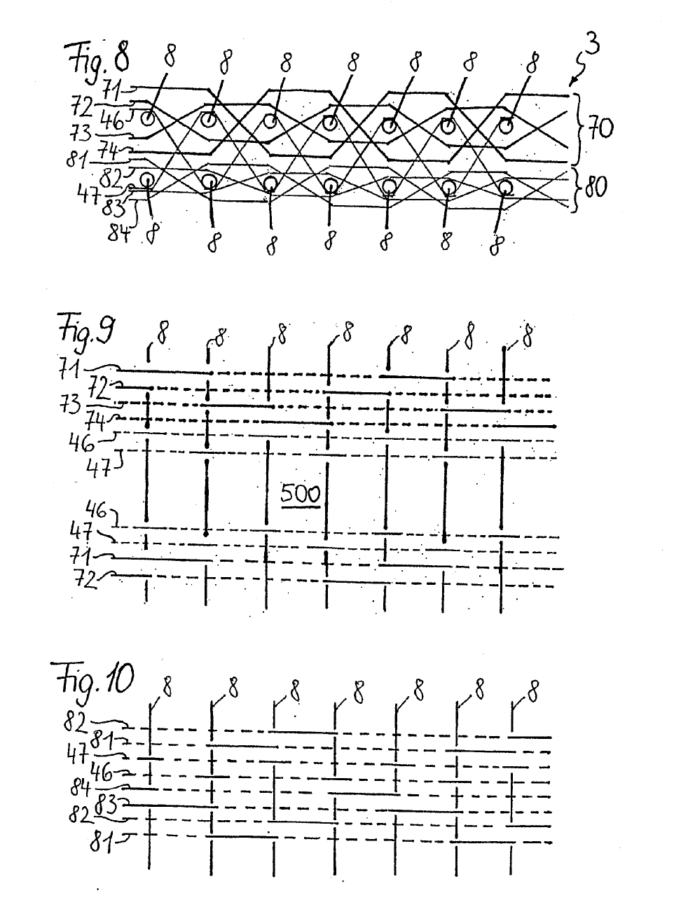

In FIGS. 8, 9, and 10, a belt 3 is illustrated that has a woven top layer 70 and a woven bottom layer 80. The warp threads 71 to 74 of the woven top layer 70 and the warp threads 81 to 84 of the woven bottom layer 80 extend in the same way as the warp threads 51 to 54 and 61 to 64 in FIG. 5. The woven top layer 70 and the woven bottom layer 80 are interwoven by binding threads 46 and 47 wherein the binding threads 46, 47 extend across a weft thread 8 of the woven layer 70 and 80, respectively. FIG. 9 shows a schematic plan view onto the woven belt 3. The warp threads 71 to 74 are interwoven adjacent to one another; adjacently positioned are the binding threads 46 and 47. The drainage passages are provided by eliminating every other warp thread sequence of the woven layer 70 so that the binding threads 46 and 47 are followed by binding threads 46 and 47; a further sequence of warp threads 71 to 74 follows. The woven bottom layer 80 illustrated in FIG. 10 as a plan view of the bottom side of the woven belt 3 is designed in accordance with the bottom layer 60 of the belt 2 illustrated in FIG. 7 wherein the warp threads 81 to 84 of the woven bottom layer 80 can all have the same diameter.

For increasing the temperature resistance and wear resistance of a woven belt 1, 2, 3, in the edge area of the woven belt in the longitudinal direction 5, 7 of the woven belt, thread material having a high temperature resistance, in particular, para-aramids or KEVLAR®, can be woven in. The temperature-resistant thread material can also extend across the entire width of the woven top layer 10, 50, 70 or a woven bottom layer 30, 60, 80 or across the woven bottom layer as well as the woven top layer. The drainage channels 500 can also be formed as openings in the woven structure. For this purpose, neighboring warp threads of a woven layer can cross one another, for example.

The thread material can be comprised of 65 percent polyester and 35 percent viscose. A different composition can also be expedient. Preferably, the thread material is a monofilament.

The material for the friction-increasing strip is preferably silicone. Polyurethane can also be advantageous.

In order to embody the woven belt to be antistatic, it is provided to admix electrically conducting metal fibers to the thread material of the weft threads and/or of the warp threads. Weft threads or ward threads of a material with admixed electrically conducting metal fibers, for example, steel fibers, can be provided in the woven top layer, in the woven central layer that takes up the tensile forces, and also in an additional woven layer; the threads are preferably provided on the paper side. It can be sufficient to provide only individual weft threads and/or warp threads in the top paper side of a material containing metal fibers in order to obtain a significant improvement of the antistatic properties of the woven belt.

When weft threads and/or warp threads of monofilament are used, the material properties of the monofilaments advantageously can be used for forming drainage channels or passages. Monofilaments have substantially pressure-stable cross-sections so that—even for a dense, tightly woven structure—the cross-sectional shapes are hardly subjected to any change. In this way, gaps, cavities and the like remain in the woven structure when, for example, monofilaments with a circular, elliptical, or similar cross-sectional shape are used. These cavities and gaps that remain even in the case of a tight packing density are embedded in such a way in the woven structure that moisture-removing passages are formed that remove the moisture from the paper side.

While specific embodiments of the invention have been shown and described in detail to illustrate the inventive principles, it will be understood that the invention may be embodied otherwise without departing from such principles.

What is claimed is:

1. A woven belt for a corrugated board machine, the woven belt comprising:
a first woven layer comprised of first warp threads and first weft threads and adapted to take up tensile forces acting on the woven belt;
a second woven layer comprised of second warp threads and second weft threads and forming a woven top layer covering the first woven layer, wherein the woven top layer forms a paper side of the woven belt on which paper side corrugated board is supported;
wherein the woven top layer is vapor permeable to allow removal of moisture from the paper side;
wherein the woven top layer comprises at least one strip of a friction-increasing material, wherein the at least one strip is narrower in a direction perpendicular to a longitudinal direction of the woven belt than a width of the woven belt.

2. The woven belt according to claim 1, wherein several of the at least one strip are arranged perpendicularly to the width of the woven belt.

3. The woven belt according to claim 2, comprising drainage channels arranged between neighboring ones of the several strips.

4. The woven belt according to claim 1, wherein the at least one strip is one of the second warp threads that is positioned at the paper side and is provided with a friction-increasing coating.

5. The woven belt according to claim 4, wherein the friction-increasing coating is comprised of silicone or polyurethane.

6. The woven belt according to claim 1, wherein several of the second warp threads have a friction-increasing coating to form the at least one strip and are positioned at the paper side in random distribution across a width of the paper side.

7. The woven belt according to claim 6, wherein the friction-increasing coating is comprised of silicone or polyurethane.

8. The woven belt according to claim 1, wherein all of the second warp threads positioned at the paper side are coated with a friction-increasing coating to form the at least one strip.

9. The woven belt according to claim 8, wherein the friction-increasing coating is comprised of silicone or polyurethane.

10. The woven belt according to claim 1, wherein the first and second warp threads and the first and second weft threads comprise electrically conducting metal fibers.

11. The woven belt according to claim 1, wherein the first and second warp threads comprise electrically conducting metal fibers.

12. The woven belt according to claim 1, wherein the first and second weft threads comprise electrically conducting metal fibers.

13. The woven belt according to claim 1, wherein the first and second warp threads and the first and second weft threads are comprised of monofilaments having a substantially pressure-stable cross-section.

14. The woven belt according to claim 1, wherein the first and second warp threads are comprised of monofilaments having a substantially pressure-stable cross-section.

15. The woven belt according to claim 1, wherein the first and second weft threads are comprised of monofilaments having a substantially pressure-stable cross-section.
